(19) United States
(12) Patent Application Publication
(10) Pub. No.: US 2003/0115571 A1
(43) Pub. Date: Jun. 19, 2003

(54) Construction of a software application from a plurality of programming languages

(75) Inventor: Viet-Hung Phan, Brossard (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(73) Assignee: Telefonaktiebolaget L M Ericsson (publ)

(21) Appl. No.: 10/014,901

(22) Filed: Dec. 14, 2001

(51) Int. Cl. G06F 9/44; G06F 9/45

(52) U.S. Cl. 717/105; 717/109; 717/113; 717/120; 717/140

(57) ABSTRACT

The present invention relates to a tool and a method for constructing a software application from a model representation. The method first involves reading the model representation before identifying in the model representation a plurality of software modules. The method then identifies a programming language for each one of the plurality of software modules. After identification of the different programming languages, the method compiles each one of the plurality of software modules into machine language using a software compiler. It is to be noted that the software compiler corresponds to the identified programming language. The methods finally links the compiled plurality of software modules into the software application. The tool comprises an interpreting module for identifying a plurality of programming languages in a source code listing and a calling module for compiling the source code listing into machine language.

### BACKGROUND OF THE INVENTION

1. Field of the Invention

This invention relates to software application programming and, more precisely, to the use of multiple programming languages in a single model representation of the software application.

2. Description of the Related Art

The development of a software application is done through a number of different steps. Most of the time, the process will start by planning the development and designing the software application before actually writing the code behind it. The code of the software application is a set of instructions written to represent the algorithms and structures identified in the design phase. The subsequent steps of compiling the code and linking the software application together are done in order to test and later execute the software application.

Depending on the size of the software application, all steps could be performed by the same person or by a group of up to a hundred people. In cases where more than one people are involved, planning the development and designing the software application become critical. Fortunately, some methods exist to help designing the software application. One of the most popular methods involves designing the application through a model representation.

A model representation of a software application can be defined as a set of graphical views of the components making up the software application and of the interaction of these components with each other. The components represented in the model are not only computer hardware or software. For example, the model representation of a software application often includes the different users of the application. The model represents the interactions that the users have with the software application. The interactions between the other components within the software application are also represented. For example, the interaction of two parts of the application exchanging data would be represented. In some cases, the model representation has different levels of detail where each level represents specific aspects of the software application.

In order to develop a model representation of a software application, developers often use some formal modeling languages. One of the most popular one is the Unified Modeling Language (UML™). It consists of a standardized representation of every component and their interaction.

There is a wide range of modeling tools offering support for one modeling language or more. Some modeling tools also offer mapping between modeling languages and one specified programming language. It is to be noted that a modeling language is independent from a programming language. The programming language represents the syntax rules in which the software application's code is written while the modeling language is a set of graphical symbols representing the relations between the software application's components.

The mapping between modeling languages and one specified programming language consists of a translation from the model representation to actual code in the specified programming language. The main advantage of mapping is being able to use the model representation to directly obtain the corresponding code. It gives the programmers the corresponding code structure. In cases where the model representation is not mapped to a programming language, the model representation still gives the programmers the necessary information to build the code of the software application.

During the design phase, the choice between structured programming and object oriented programming must also be done. There are major distinctions between the two programming paradigms. In structured programming, the starting point is an action to be performed. Every action is seen as a sequence of logical steps leading to a final result. Most of the time, structured programming code is divided into smaller sections called subfunctions. In object oriented programming, the starting point is an object or component. Every object has a predetermined behavior and referencing a given object with specific parameters will lead to a final result. When the design phase is done using a model representation, the natural choice is to go with object oriented programming since components are the basic point of every model.

The design phase of the software application is completed when the model representation gives the necessary information to complete the coding of the software application. In most cases, completion of the design phase means that the model representation covers the major components of the software application and their interactions with each other. The model representation obtained at the end of the design phase will lead to a plurality of modules forming the software application. In the case of object oriented programming, those modules are often referred to as classes. When the design phase is done properly, the coding phase should not present big problem. In fact, the major issue of the coding phase is to convert the result of the design phase into the correct code syntax of the chosen programming language.

Once the coding phase is completed, it must be converted from clear text to machine language. This is done through a compiling software called compiler. Basically, a compiler is a software application capable of translating a given programming language syntax into machine language. Some modeling tools offering mapping with one programming language may also provide a compiler. The compiler must know on which platform the software application is to be used. For example, the compilation is quite different if the application is to run on an Intel® processor (e.g. i80386) or on a Motorola processor (e.g. MC68000). The platform information is provided by some configurable parameters inside the modeling tool.

The compiling step of a software application will result in a plurality of machine language files with typically one file per module. After the compiling step, it is almost impossible to recognize the programming paradigm used or the initial programming language. It is to be noted that some precompiled libraries exist enabling a programmer to use a set of known function in the software application.

The final phase before the software application is ready is linking. Basically, all the files obtained from the compiling step are arranged together to produce one or more executable files. Some more complete modeling tools providing a compiler may also provide linking capabilities. If some libraries are used by the software application, the corresponding precompiled files must also be added during the linking process. The destination platform of the software application must be known to the modeling tool to make sure the final result will be compatible with both the Operating System (OS) and the processor type. The platform information, as previously said, is provided by some configurable parameters inside the modeling tool.

Reference is now made to the Drawings where FIG. 1 shows a flow chart for constructing a software application according to prior art. The presented method could be implemented by a modeling tool offering linking capabilities. In such a case, the first step to obtain the final executable is reading the model representation 110 from the modeling tool. This step takes completion of the design phase for granted. Because the tool provides a complete mapping with a predetermined programming language, the result of the reading 110 step is the complete source code of the software application. The next step is compiling the code of the software application 120. The result of the compilation 120 is a plurality of compiled files. The compiled files necessary to obtain the software application also comprise the eventual libraries files. The last step is linking the compiled files into the software application 130.

In the context of the present document, a software application can be defined as a set of instructions executed by one or more computers. The set of instructions of one software application can also be distributed over a network of computers. A plurality of software applications may also be regrouped to form a library of software applications. The resulting library would still be considered an individual software application. Also, the software application can be designed to run on single processor computers as well as on multiprocessor computers. The set of instructions comprised in the software application can be stored on volatile or non-volatile storage.

The method described previously does not give the opportunity for a large group of people to work on the same software application through a modeling tool using different programming languages. The present invention provides solutions to such a problem.

### SUMMARY OF THE INVENTION

The present invention relates to a method for constructing a software application from a model representation. The method first involves reading the model representation before identifying in the model representation a plurality of software modules. The method then identifies a programming language for each one of the plurality of software modules. After identification of the different programming languages, the method compiles each one of the plurality of software modules into machine language using a software compiler. It is to be noted that the software compiler corresponds to the identified programming language. The methods finally links the compiled plurality of software modules into the software application.

The present invention is also further directed to a tool for constructing a software application. The tool comprises an interpreting module for identifying a plurality of programming languages in a source code listing and a calling module for compiling the source code listing into machine language.

### BRIEF DESCRIPTION OF THE DRAWINGS

A more complete understanding of the present invention may be had by reference to the following Detailed Description when taken in conjunction with the accompanying drawings wherein:

FIG. 1 is a flow chart for constructing a software application according to prior art;

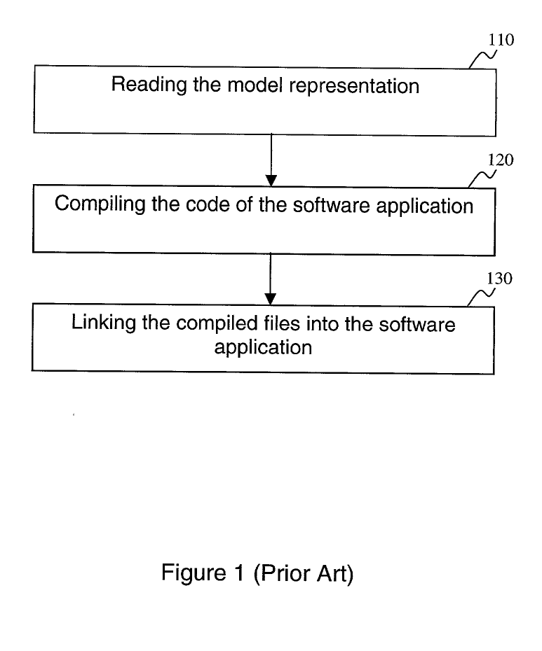

FIG. 2 is a flow chart for constructing a software application from a plurality of programming languages;

FIG. 3 is a flow chart of an example of construction of a software application from a plurality of programming languages; and

FIG. 4 is a modular representation of a tool for constructing a software application from a plurality of programming languages.

### DETAILED DESCRIPTION OF THE PREFERRED EMBODIMENTS

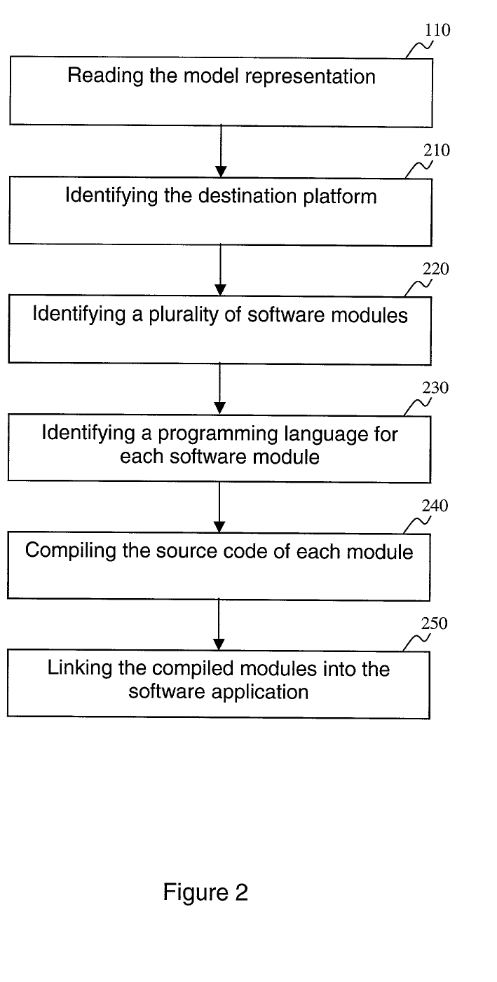

Reference is now made to the Drawings, where FIG. 2 depicts a flow chart for constructing a software application from a plurality of programming languages. A model representation of a software application can be defined as a set of graphical views of the components making up the software application and of the interaction of these components with each other. Once the model representation is completed, the construction of the software application starts by reading the model representation, step 110, from one or more electronic files. The one or more electronic files comprises all the information gathered during the creation of the model representation. The information from the one or more electronic files is exchanged with the user of the model representation via a Graphical User Interface (GUI). It is to be noted that more than one user could eventually access the model representation at the same time from distant locations.

Some of the information gathered during the creation of the model representation is used for identifying a destination platform, step 210, for the software application. The destination platform can be identified implicitly taking into account the platform used during the creation of the model representation. In the context of the present invention, the destination platform can be defined as a set of Operating System (OS) or Real Time Operating System (RTOS) and processor architecture. For example, the destination platform of a software application could be Microsoft® Windows® NT Workstation as the OS and Intel® i386™ as the processor architecture. (Processor architecture such as Intel® i8086™, i186™, i286™, i386™, i486™, Pentium®, Pentium® II, Pentium® III, Pentium® 4, Celeron®, Xeon™, Itanium™ and next generations and compatible (for example AMD® and Transmeta Crusoe™), DEC Alpha, Motorola 6800, 68000 and next generations and compatible, PowerPC®, JAVA™, C/C++, VAX®, Cyrix®, IBM® and other proprietary processor architectures. OS such as Linux, Unix®, Microsoft® Windows® families (95/98/ME, NT/2000, XP), DOS (PC-DOS®, MS-DOS® and Compatible), OS2® warp, Be-OS®, MAC OS® (System X®), VxWorks®, PSOS®, OSE®, QNX®, NeXT® and other proprietary OS. Another example of destination platform could be a proprietary operating system with a proprietary processor architecture. The proprietary operating system, as the processor architecture, could very well be developed to run only the developed software application.

The step of identifying in the model representation a plurality of software modules 220 can occur at any time after reading the model representation 110 is completed. The plurality of software modules are identified according to a plurality of logical separators inside the model representation. If the programming paradigm used for the software application is Object Oriented, the plurality of logical separators most of the time corresponds to the different classes of the software application. If structured programming was used instead of Object Oriented, the plurality of logical separators are then represented by the different subfunctions forming the software application. In either case, the identified plurality of software modules can stand in one or more electronic files. A single software module can also be split in more than one electronic files.

When all the software modules are identified, the step of identifying a programming language for each software module, step 230, can occur. This step also comprises generating the corresponding source code. The main idea is to be able to work with different programming languages in the same model representation. Two different approaches can be used in order to do so. It is possible to analyze the syntax of the generated source code to detect the corresponding programming language. For example, the analysis of the generated source code can be based on a list of keywords used in a specific programming language thus distinguishing one programming language from others.

The other approach is to have the user of the model representation to enter the information concerning the programming language used for each software module. In this second case, some of the information gathered during the creation of the model representation will be used to identify the corresponding programming language code for each one of the plurality of software modules. (Programming languages such as Ada, ALGOL, Assembly, C/C++, COBOL, FORTRAN, Java™, Pascal, Perl, PL/I, Basic and family (Visual Basic™, Quick Basic™), PHP, ASP, Delphi™, SQL, CGI, XML, HTML, WAP and other proprietary programming languages.)

Once the source code of the each one of the plurality of software module is obtained, compiling each software module, step 240, must be done. The compiling of each one of the plurality of software modules into machine language is achieved using a software compiler. The software compiler must correspond to the previously identified programming language. In other word, it takes a software compiler for each of the identified programming language. This does not restrict a software compiler to only one programming language, but every programming language must have one compatible software compiler.

The software compilers used during the construction of the software application can be complete independent software application that could be used by other external software applications. The software compilers can also be incorporated in the modeling tool. The incorporated software compilers cannot be used by external software applications.

It is to be noted that the step of identifying a destination platform 210 could take place anywhere in the sequence of steps after reading the model representation 110 and before compiling the source code of each module 240.

The last step in order to obtain the constructed software application is linking the compiled plurality of software modules into the software application 250. It is done via a software linker that could either be incorporated in the tool or a complete independent software application.

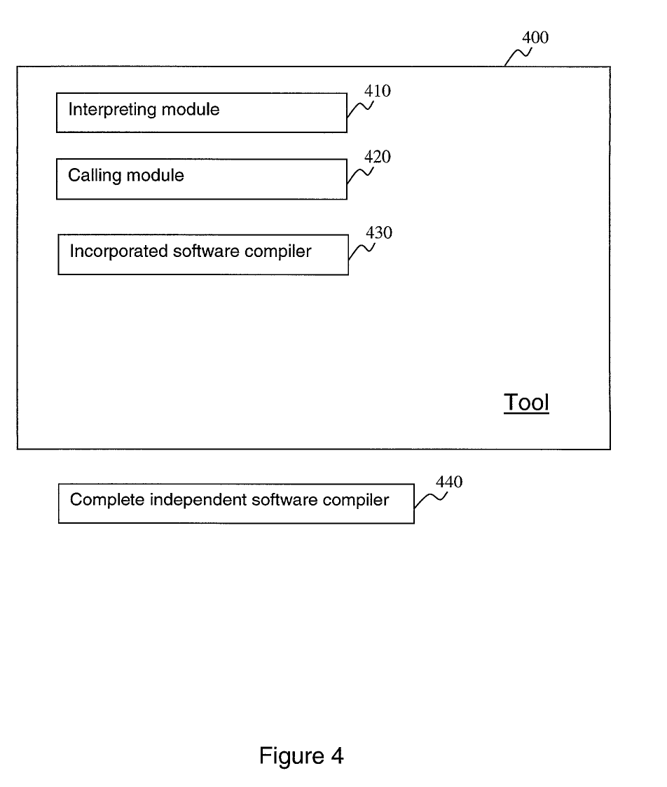

FIG. 4 shows a modular representation of a tool for constructing a software application from a plurality of programming languages. The tool 400 contains an interpreting module 410 for identifying a plurality of programming languages in a source code listing and a calling module 420 for compiling the source code listing into machine language. It is to be noted that the source code listing can be contiguous or separated in multiple parts. For example, the multiple parts can be stored in different electronic files.

The calling module 420 uses an appropriate software compiler for compiling each one of the plurality of programming languages. The calling module 420 can also use a plurality of appropriate software compilers for compiling each one of the plurality of programming languages. Again, a software compiler could either be incorporated in the tool 430 or a complete independent software application 440. It is to be noted that the plurality of software compilers can also be composed of at least one complete independent software compiler 440 and at least one software compiler incorporated in the tool 430.

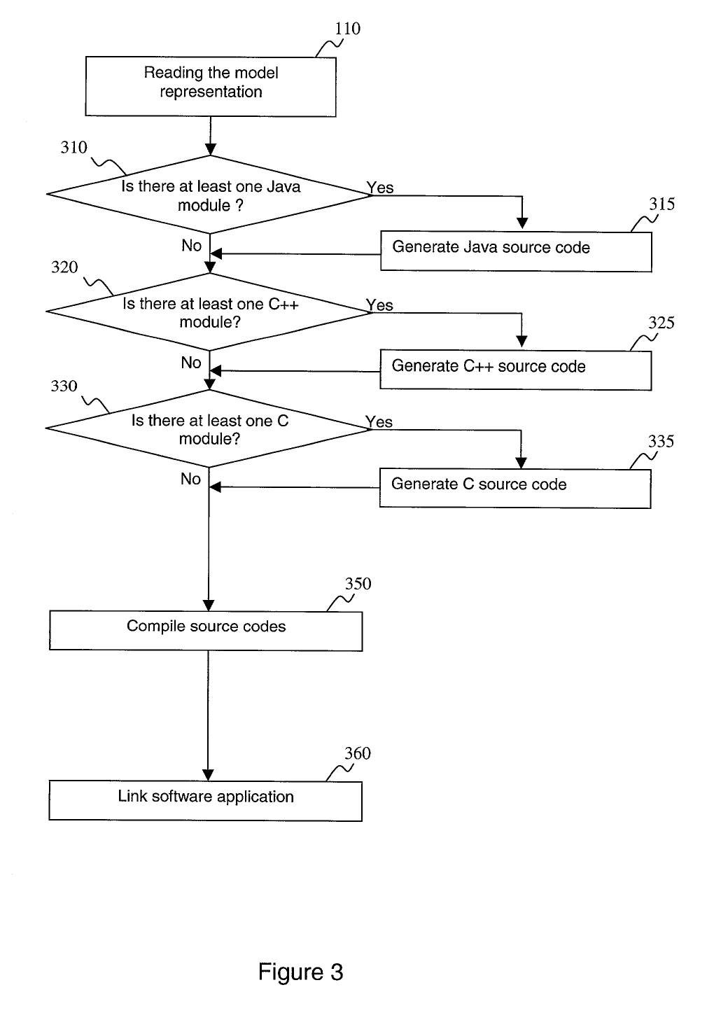

FIG. 3 depicts a flow chart of an example of construction of a software application from a plurality of programming languages. After reading the model representation 110, the model representation is sought to find out if there is at least one Java™ module 310. If it is the case, the source code for every Java™ module is generated 315. The same principle applies to find C++ 320 and C 330 modules. If it is the case, the source code for every corresponding module is generated in steps 325 and 335 respectively. These two steps—find and generate—could be repeated for other known programming languages.

All the generated source code are then compiled 350 with one or many appropriate software compilers before being linked together by the software linker to obtain the software application 360. In many cases all those steps are automated by using a batch file, often called “makefile”, containing all the necessary information to perform the sequence of operation to construct the software application.

Although several preferred embodiments of the method and the tool of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for constructing a software application from a model representation, the method comprising steps of:
reading the model representation;
identifying in the model representation a plurality of software modules;
identifying a programming language for each one of the plurality of software modules;
compiling each one of the plurality of software modules into machine language using a software compiler, the software compiler corresponding to the identified programming language; and
linking the compiled plurality of software modules into the software application.

2. The method of claim 1 wherein the step of reading the model representation further comprises the step of reading the model representation from one or more electronic files.

3. The method of claim 1 wherein the step of reading the model representation further comprises step of identifying a destination platform to the software application.

4. The method of claim 3 wherein the machine language is compatible with the identified destination platform.

5. The method of claim 3 wherein the destination platform comprises a processor architecture and an Operating System (OS).

6. The method of claim 4 wherein the OS can be one of Microsoft Windows™ based OS, UNIX™ based OS, and Linux based OS, a real-time OS or a proprietary OS.

7. The method of claim 1 wherein the model representation is a graphical representation.

8. The method of claim 7 wherein the graphical representation conforms to the Unified Modeling Language (UML™) symbolic representation.

9. The method of claim 1 wherein the model representation is a textual representation.

10. The method of claim 1 wherein the identified programming language can be one of: Java™, C/C++, Ada, ALGOL, Assembly, COBOL, FORTRAN, Pascal, Perl, PL/I, Basic and family (Visual Basic™, Quick Basic™), PHP, ASP, Delphi™, SQL, CGI, XML, HTML, WAP or a proprietary programming language.

11. The method of claim 1 wherein the step of identifying a programming language for each one of the plurality of software modules further comprises step of generating the corresponding source code.

12. The method of claim 11 wherein the step of compiling each one of the plurality of software modules into machine language using a software compiler further comprises compiling the generated source code.

13. The method of claim 1 wherein a plurality of software compilers corresponding to the identified programming language are used.

14. The method of claim 1 wherein the software compiler is a complete independent software application.

15. The method of claim 1 wherein the software compiler is an incorporated software application.

16. A tool for constructing a software application, the tool comprising:
an interpreting module for identifying a plurality of programming languages in a source code listing; and
a calling module for compiling the source code listing into machine language.

17. The tool of claim 16 wherein the source code listing is contiguous or separated in multiple parts.

18. The tool of claim 16 wherein the calling module uses a plurality of appropriate software compilers for compiling each one of the plurality of programming languages.

19. The tool of claim 18 wherein at least one of the plurality of software compilers are complete independent software applications.

20. The tool of claim 18 wherein at least one of the plurality of software compilers is incorporated in the tool.
